(19) United States
(12) Patent Application Publication
(10) Pub. No.: US 2006/0151017 A1
(43) Pub. Date: Jul. 13, 2006

(54) Systems and methods for surface pasteurization of produce

(75) Inventors: David K. Lewis, Salinas, CA (US); Miguel Guzman, Salinas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Fresh Express, Inc., Salinas, CA (US)

(21) Appl. No.: 11/375,468

(22) Filed: Mar. 13, 2006

Related U.S. Application Data
(62) Division of application No. 10/609,135, filed on Jun. 27, 2003.
(60) Provisional application No. 60/393,012, filed on Jun. 28, 2002.

(51) Int. Cl. B08B 3/00

(52) U.S. Cl. 134/137; 134/165

(57) ABSTRACT

A method of transporting produce on a conveyor and rotating the produce substantially continuously during the transport. While the produce is being transported, steam is applied to an outer surface of the produce on the conveyor. Lane dividers are provided along the conveyor in a direction of travel of the conveyor to prevent the produce from touching each other and to help keep the produce rotating in various directions.

### CROSS-REFERENCES TO RELATED APPLICATIONS

This application claims priority from Provisional Application No. 60/393,012, filed Jun. 28, 2002, the disclosure of which is incorporated herein by reference.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

1. Field of the Invention

The present invention relates to systems and methods for surface pasteurization for fruits and vegetables, and more particularly, to systems and methods for surface pasteurization of hard fruits such as melons.

2. Description of the Prior Art

Fruit and vegetables, particularly melons and other produce that grows on the ground, have a high natural occurrence of bacteria on their surfaces. Some of the bacteria, e.g., salmonella, listeria, and coliform, are responsible for many cases of sickness and, occasionally even death, each year.

Typically, melons are washed on rotating brushes under a water spray containing chlorine to reduce the bacteria population on their surface. When melons are processed for sale as fresh cut fruit, they are often soaked in a water solution containing chlorine in an attempt to further reduce the bacteria population. At best these methods result in a bacteria reduction level that does not assure a safe food product.

Brushes used to clean fruit become packed with organic residue and foreign material being removed from the surface of the fruit. It is difficult to effectively clean between the bristles. Brushes harbor bacteria and pose the risk of transmitting bacteria to the fruit that they are presumably cleaning. Spraying the brushes continuously with chlorinated water helps to control the bacteria level, but does not eliminate the risk.

Indirect continuous pasteurization may be achieved using a commercial vegetable blancher. The food product is generally transported through an insulated chamber on an open mesh conveyor belt. Steam is typically injected from above and/or below the conveyor and raises the air temperature within the chamber to a prescribed temperature. The objective of blanching is to heat the entire volume of the product to a uniform temperature, generally 200 F and below. Blanching time needs to be long enough to permit heat to penetrate the full profile of the product and to maintain the prescribed temperature for sufficient time to achieve the desired effect of deactivating enzymes and killing harmful bacteria. If the temperature is too high both flavor and texture may be destroyed.

### SUMMARY OF THE INVENTION

The present invention provides a method of cleaning and preparing produce. The method includes transporting the produce on a conveyor and rotating the produce substantially continuously during the transporting. While the produce is being transported, steam is applied to an outer surface of the produce on the conveyor.

According to one aspect of the present invention, the steam is applied at a pressure at a range of 20-100 psi.

In accordance with another aspect of the present invention, the method further includes washing the produce on the conveyor.

In accordance with a further aspect of the present invention, the washing is done prior to applying steam.

In accordance with yet another aspect of the present invention, the washing is done after applying steam.

The present invention also provides a system for cleaning and preparing produce. The system includes a housing that includes an entrance and an exit. A rotating conveyor extends from at least the entrance to the exit. A steam pasteurization station is included within the housing. The steam pasteurization station includes a plurality of steam jets arranged above the rotating conveyor. Some of the steam jets are arranged off-center with respect to the rotating conveyor.

In accordance with one aspect of the present invention, the system includes a wash station within the housing.

In accordance with a further aspect of the present invention, the wash station is located prior to the pasteurization station.

In accordance with yet another aspect of the present invention, the wash station is located after the pasteurization station.

In accordance with yet a further aspect of the present invention, the rotating conveyor includes a series of transfer rollers coupled at their ends to a pair of roller chains. The rotating conveyor also includes a rack and pinion drive coupled to the rollers.

The preferred exemplary embodiments of this invention will now be discussed in detail. These embodiments depict the novel and nonobvious pasteurization systems and methods of this invention shown in the accompanying drawings, which are included for illustrative purposes only, with like numerals indicating like elements.

### BRIEF DESCRIPTION OF THE DRAWINGS

FIG. 1 is a schematic illustration of a steam pasteurization system in accordance with the present invention; and

FIG. 2 is an illustration of a conveyor system of the system illustrated in FIG. 2 including rails for dividing the conveyor system into lanes.

### DESCRIPTION OF PREFERRED EXEMPLARY EMBODIMENTS OF THE INVENTION

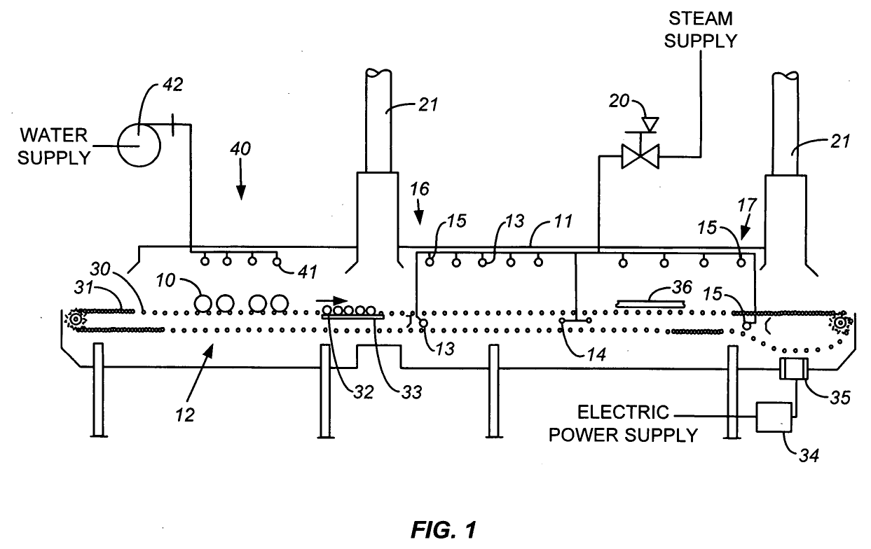

With reference to FIG. 1, fruit or produce 10 is transported through a steam chamber 11 on a translating and rotating bed of rollers that form a conveyor 12. Steam nozzles 13 located above the conveyor point down and spray pressurized steam on the fruit as it passes underneath. Constant rotation of the fruit is combined with strategic placement of the nozzles that helps assure that all external surfaces of the fruit come into direct contact with steam. Steam nozzles 14 are preferably located below the rollers and pointing upward to induce circulation of steam within the chamber. Steam nozzles 15 may be provided at entrance 16 and exit 17 of the chamber to help retain steam within the chamber 11 and increase air temperature within the chamber. Rotary valves, which are well known in the art, may be used to provide a similar effect, but are generally more complex and costly.

The steam pressure is preferably in the range of 20-100 psig. Increasing pressure causes the velocity of steam exiting the nozzles to increase and thus, increases steam flow rate through the nozzles. Adjusting steam pressure with a flow control valve 20 is a preferred way to vary the quantity of steam applied to match requirements. Those skilled in the art will understand that proper steam pressure setting is also influenced by orifice diameter of the nozzles. The steam chamber is preferably at atmospheric pressure and therefore, temperature in the chamber preferably does not exceed 212 F. Steam is preferably exhausted from the chamber through exhaust ducts 21 located at each end of the chamber.

With the present invention, the surface pasteurization only heats the surface of the product to a desired temperature and does not allow heat to penetrate into the product and raise the temperature of the interior flesh. The cumulative effect of time and temperature kills bacteria microorganisms including bacteria, yeast and mold. Higher temperatures require shorter times. Shorter times result in less heat penetration into the interior of the product. In a continuous commercial pasteurizer retention times could vary from 2-10 minutes.

With reference to FIG. 1, rotating bed conveyor preferably includes a series of transverse rollers 30 supporting the fruit that are connected at their ends to a pair of roller chains 31 that move in a perpendicular direction to the rollers. The forward motion of the chain propels the tubes forward. A rack 32 and pinion drive 33 located on the extremity of the rollers causes the tubes to rotate as they translate forward. Those skilled in the art will understand that other types of traction devices may be used to serve the same purpose.

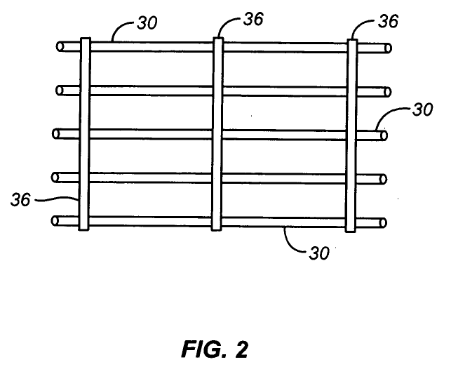

With reference to FIG. 2, rails 36 are preferably provided along the sides of the conveyor belt and down the middle of the conveyor. Preferably, at least one rail 36 is provided down the middle of the conveyor. This middle rail divides the conveyor system into channels thereby helping prevent the fruit from touching one another. Additionally; these rails help keep the fruit rotating both along a direction of travel for the conveyor system as well as a direction transverse to the direction of travel of the conveyor system.

Rails 36 may comprise a suitable type of metal, plastic, etc. that is able to withstand the temperatures and liquids of the wash system. While only one rail is illustrated down the middle in FIG. 2, those skilled in the art will understand that multiple rails may extend between the outer rails along a direction of travel of the conveyor system in order to create multiple channels.

The rails may be suspended from the roof of the chamber or may be coupled with an extension that extends between the conveyors and thus are coupled to a base or structure of the chamber below the conveyors.

Retention time in the steam chamber is controlled by the speed of the conveyor belt. In a preferred embodiment, belt speed is varied with a variable frequency drive 34 for an electric motor 35, or a flow-control valve (not shown), if a hydraulic motor is used.

A washing system 40 may be incorporated into the pasteurizer system by extending the entrance of the roller bed and adding medium pressure water spray nozzles 41 over the extended portion of the roller bed. Pressure is produced with a pump 42. Preferably, wash pressure is in a range of 100-300 psi. As with the steam portion of the system, rotation of the fruit and strategic nozzle placement assure all surfaces are exposed to the water sprays. A sanitizing agent such as chlorine may be added to the water to increase the effectiveness of the wash. An additional benefit occurs in such a wash section since the rollers are washed as they repeatedly pass through the wash section and are then heat sanitized when they pass through the pasteurization section. By incorporating the two processes on the same conveyor, a transfer is eliminated which reduces product damage and eliminates a conveyor drive.

Preferably, the fruit is cooled in 33 to 45 F chlorinated chilled water after removal from the system. Cooling is believed to enhance the effect of the pasteurization, but is generally not an essential part of the pasteurization process.

Research has been conducted using an experimental test chamber for the present invention. Using canteloupe and honeydew melons, it was found that brushing under chlorinated sprays followed by immersion for 120 seconds in a chlorine solution 200 ppm free chlorine produced a max. 2-log total aerobic plate count (TPC) reduction on the surface of the melons. Exposing the washed melons to 210 F indirect steam at atmospheric pressure for 150 seconds resulted in a max. 3-log TAPC reduction while a 180-second exposure time yielded a max. 4-log reduction.

Rotating washed melons in a direct jet of 210 F steam at atmospheric pressure proved to be a most effective method. A 150-second exposure time produced a 5-log reduction. Currently, the USDA requires a 5-log reduction before fruit juices may be labeled pasteurized.

Bacteria contamination most commonly occurs on the surface of the fruit. Subjecting the fruit to a temperature of 210 F for 210 seconds generally provides the satisfactory 5-log TAPC reduction to a surface depth of 2 mm. The research indicates that direct steam injection is more effective at achieving this than indirect injection.

Although the invention has been described with reference to specific exemplary embodiments, it will appreciated that it is intended to cover all modifications and equivalents within the scope of the appended claims.

1-7. (canceled)

8. A system for cleaning and preparing produce, the system comprising:
a housing comprising an entrance and an exit;
a rotating conveyor extending from at least the entrance to the exit; and
a steam pasteurization section within the housing, the steam pasteurization station comprising a plurality of steam jets arranged around the rotating conveyor, wherein some of the steam jets are arranged off-center with respect to the rotating conveyor.

9. A system in accordance with claim 8 further comprising a wash station with the housing.

10. A system in accordance with claim 9 wherein the wash station is located prior to the pasteurization station.

11. A system in accordance with claim 10 wherein the wash station is located after the pasteurization station.

12. A system in accordance with claim 8 wherein the rotating conveyor comprises a series of transverse rollers coupled at their ends to a pair of roller chains, and a rack and pinion drive coupled to the rollers.

13. A system in accordance with claim 8 further comprising lane dividers extending longitudinally along the rotating conveyor a direction of travel of the conveyor.
